(19) United States
(12) Patent Application Publication
(10) Pub. No.: US 2024/0410617 A1
(43) Pub. Date: Dec. 12, 2024

(54) HEAT EXCHANGER ASSEMBLY AND WATER HEATER

(71) Applicant: WUHU MIDEA SMART KITCHEN APPLIANCE MANUFACTURING CO, LTD., Wuhu (CN)

(72) Inventor: Yipeng WU, Wuhu (CN)

(21) Appl. No.: 18/810,101

(22) Filed: Aug. 20, 2024

Related U.S. Application Data
(63) Continuation of application No. PCT/CN2023/103285, filed on Jun. 28, 2023.

(30) Foreign Application Priority Data
Dec. 30, 2022 (CN) 202211736492.1

(51) Int. Cl. F24H 8/00; F24H 1/10; F24H 9/00

(52) U.S. Cl. CPC F24H 8/006; F24H 1/107; F24H 9/0031

(57) ABSTRACT

A heat exchanger assembly includes a combustion assembly having a combustion chamber, a first heat exchanger, a flue gas passage having a condensation chamber, and a second heat exchanger. The first heat exchanger is located in the combustion chamber. The flue gas passage is configured to receive flue gas from the combustion chamber and to discharge the flue gas out of the heat exchanger assembly. The second heat exchanger is disposed in the condensation chamber and is configured to exchange heat with the flue gas entering the flue gas passage.

### CROSS-REFERENCE TO RELATED APPLICATIONS

The present application is a continuation of International Application No. PCT/CN2023/103285, filed on Jun. 28, 2023, which claims priority to Chinese Patent Application No. 202211736492.1, filed on Dec. 30, 2022, both of which are hereby incorporated by reference in their entireties.

### FIELD

The present disclosure relates to the field of water heater technologies, and more particularly, to a heat exchanger assembly and a water heater.

### BACKGROUND

A large amount of heat exists in flue gas discharged by a conventional gas water heater. Since the heat in the flue gas is unable to be exchanged with water in the heat exchanger assembly, energy cannot be fully utilized. Therefore, an energy efficiency of the water heater fails to meet a high standard, leading to wasted energy.

### SUMMARY

The present disclosure aims to solve at least one of the above-mentioned technical problems in the related art to some extent. To this end, the present disclosure provides a heat exchanger assembly. The heat exchanger assembly is capable of simplifying a structure of the heat exchanger to reduce an overall volume of a water heater while improving a heat exchange efficiency to achieve energy saving and emission reduction.

The present disclosure further provides a water heater having the above-mentioned heat exchanger assembly.

According to an embodiment of the present disclosure, the heat exchanger assembly includes: a combustion assembly having a combustion chamber; a first heat exchanger located in the combustion chamber; a flue gas passage having a condensation chamber, the flue gas passage being configured to receive flue gas from the combustion chamber and to discharge the flue gas out of the heat exchanger assembly; and a second heat exchanger disposed in the condensation chamber and configured to exchange heat with the flue gas entering the flue gas passage.

With the heat exchanger assembly according to the embodiment of the present disclosure, the structure of the heat exchanger can be simplified to reduce the overall volume of the water heater while the heat exchange efficiency can be improved to achieve the energy saving and emission reduction.

In addition, the heat exchanger assembly according to the embodiment of the disclosure can further have the following additional technical features.

According to some embodiments of the present disclosure, the combustion assembly includes a combustion housing. The flue gas passage includes a flue gas housing. The flue gas housing is disposed at a top of the combustion housing.

According to some embodiments of the present disclosure, a first partition is provided between the flue gas housing and the combustion housing, the first partition being configured to separate the combustion chamber from the condensation chamber.

According to some embodiments of the present disclosure, a communication opening is formed between the first partition and the flue gas housing and/or the combustion housing, the condensation chamber being in communication with the combustion chamber through the communication opening.

According to some embodiments of the present disclosure, a surface of the first partition facing towards the combustion chamber is constructed as a first guide surface, the first guide surface being configured to guide the flue gas from the combustion chamber to flow towards the communication opening.

According to some embodiments of the present disclosure, the heat exchanger assembly further includes a condensate water collector. A surface of the first partition facing towards the condensation chamber is constructed as a second guide surface. The second guide surface is configured to at least guide condensate water in the condensation chamber to flow towards the condensate water collector.

According to some embodiments of the present disclosure, the first partition is located at a bottom of the flue gas housing and has a first end connected to a first wall of the flue gas housing

According to some embodiments of the present disclosure, the first partition has a second end spaced apart from a second wall of the flue gas housing to form the communication opening, the first wall being arranged opposite to the second wall.

According to some embodiments of the present disclosure, the condensate water collector is disposed at the first partition and close to the first wall.

According to some embodiments of the present disclosure, the first wall of the flue gas housing extends beyond a side wall of the combustion housing at a same side as the first wall to form a mounting space between the first wall and the side wall of the combustion housing, the condensate water collector extending into the mounting space.

According to some embodiments of the present disclosure, the heat exchanger assembly further includes a drainage pipe connected to the condensate water collector and located in the mounting space.

According to some embodiments of the present disclosure, the heat exchanger assembly further includes a second partition disposed in the flue gas passage and located opposite to the combustion chamber with respect to the first partition.

According to some embodiments of the present disclosure, the condensation chamber is located between the first partition and the second partition.

According to some embodiments of the present disclosure, the second partition is located above the first partition, a surface of the second partition facing towards the first partition being constructed as a third guide surface for guiding the flue gas.

According to some embodiments of the present disclosure, the flue gas housing has a first wall and a second wall opposite to the first wall. The second partition has a first end spaced apart from the first wall to form an exhaust outlet for exhausting the flue gas and a second end connected to the second wall.

According to one embodiment of the present disclosure, a water heater includes the above-mentioned heat exchanger assembly.

Additional aspects and advantages of the present disclosure will be provided at least in part in the following description, or will become apparent at least in part from the following description, or can be learned from practicing of the present disclosure.

### BRIEF DESCRIPTION OF THE DRAWINGS

The above and/or additional aspects and advantages of the present disclosure will become more apparent and more understandable from the following description of embodiments taken in conjunction with the accompanying drawings, in which:

FIG. 1 is a schematic structural view of a water heater according to an embodiment of the present disclosure.

FIG. 2 is a sectional view of a water heater according to an embodiment of the present disclosure.

FIG. 3 is an exploded view of a water heater according to an embodiment of the present disclosure.

FIG. 4 is a sectional view of a flue gas passage according to an embodiment of the present disclosure.

FIG. 5 is a schematic structural view of a second heat exchanger according to an embodiment of the present disclosure.

FIG. 6 is a schematic structural view of a second heat exchanger according to an embodiment of the present disclosure.

FIG. 7 is a schematic structural view of a second heat exchanger according to an embodiment of the present disclosure.

FIG. 8 is a schematic structural view of a heat exchange tube according to an embodiment of the present disclosure.

FIG. 9 is a schematic partial structural view of a heat exchange tube according to an embodiment of the present disclosure.

Reference numerals of the accompanying drawings:

water heater 1000, flue gas passage 100, condensation chamber 10, communication opening 20, exhaust outlet 30, flue gas housing 1, first wall 11, second wall 12, first partition 2, first guide surface 21, second guide surface 22, second partition 3, third guide surface 31,

second heat exchanger 4, heat exchange tube 41, tube body 411, fin member 412, recess 413, crease 414, to-be-machined segment 415, transition segment 416, first cut edge 417, second cut edge 418, third cut edge 419,

condensate water collector 5,

combustion assembly 200, combustion chamber 201, first heat exchanger 202, combustion housing 203, mounting space 300, drainage pipe 301.

### DETAILED DESCRIPTION OF THE EMBODIMENTS

Embodiments of the present disclosure will be described in detail below with reference to examples thereof as illustrated in the accompanying drawings, throughout which same or similar elements, or elements having same or similar functions, are denoted by same or similar reference numerals. The embodiments described below with reference to the drawings are illustrative only, and are intended to explain, rather than limit, the present disclosure.

In the present disclosure, unless expressly stipulated and defined otherwise, the first feature “on” or “under” the second feature may include that the first feature is in direct contact with the second feature, or further include that the first and second features are in indirect contact through another feature between the first and second features. Moreover, the first feature “above” the second feature may mean that the first feature is directly above or obliquely above the second feature, or simply mean that the level of the first feature is higher than that of the second feature. The first feature “below” the second feature may mean that the first feature is directly below or obliquely below the second feature, or simply mean that the level of the first feature is smaller than that of the second feature.

A water heater in the embodiments of the present disclosure may be a gas water heater. A heat exchanger assembly is a core assembly in the water heater. Water in the water heater is subjected to a heat exchange within the heat exchanger assembly.

It was found that to utilize energy in flue gas, if a large and complex two-stage heat exchange structure is added to the heat exchanger to perform a heat exchange with the flue gas, an overall volume of the water heater may be increased, a processing technology may be complex, and a manufacturing cost may be high. A large amount of heat exists in flue gas discharged by a conventional gas water heater. Since the heat in the flue gas is unable to be exchanged with water in the heat exchanger assembly, energy cannot be fully utilized. Therefore, an energy efficiency of the water heater fails to meet a high standard, leading to wasted energy. To utilize the energy in the flue gas, the large and complex second-stage heat exchange structure needs to be added to the heat exchanger to perform the heat exchange with the flue gas, which leads to an increase in the overall volume of the water heater, the complex processing technology, and the high manufacturing cost.

To this end, according to the embodiments of the present disclosure, a heat exchanger assembly is designed such that a second heat exchanger 4 disposed in a flue gas passage 100 is used for a heat exchange with the flue gas. Therefore, with the heat exchanger assembly, when the energy in the flue gas is utilized, a heat exchange efficiency is improved to achieve energy saving and emission reduction. Further, a smaller space is occupied by the heat exchanger assembly, which allows an overall structure of the heat exchanger to be simple and compact. In this way, the structure of the heat exchanger is simplified to reduce an overall volume of a water heater 1000, which facilitates manufacturing and applications of the water heater 1000.

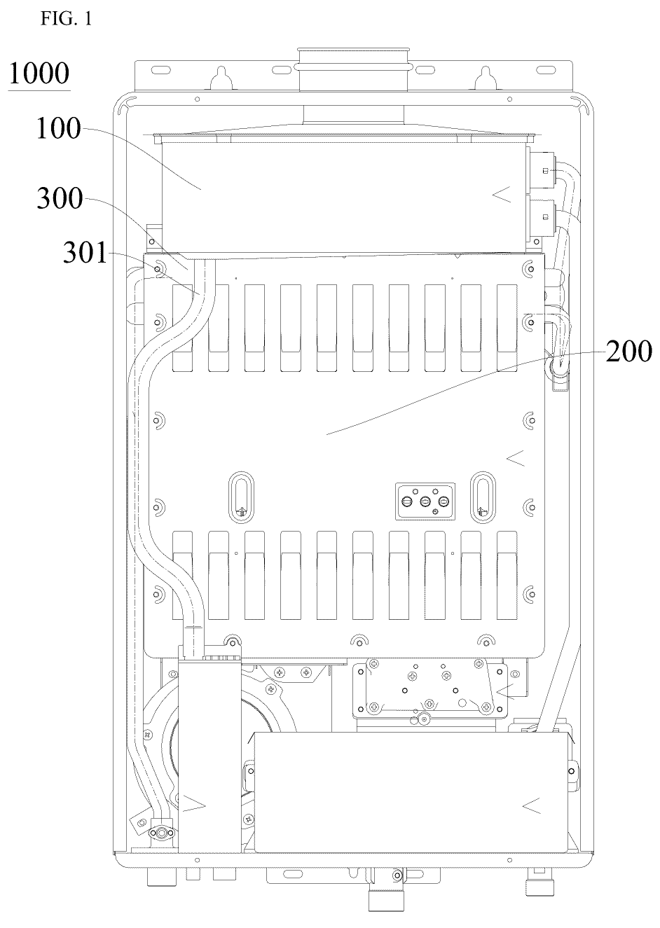

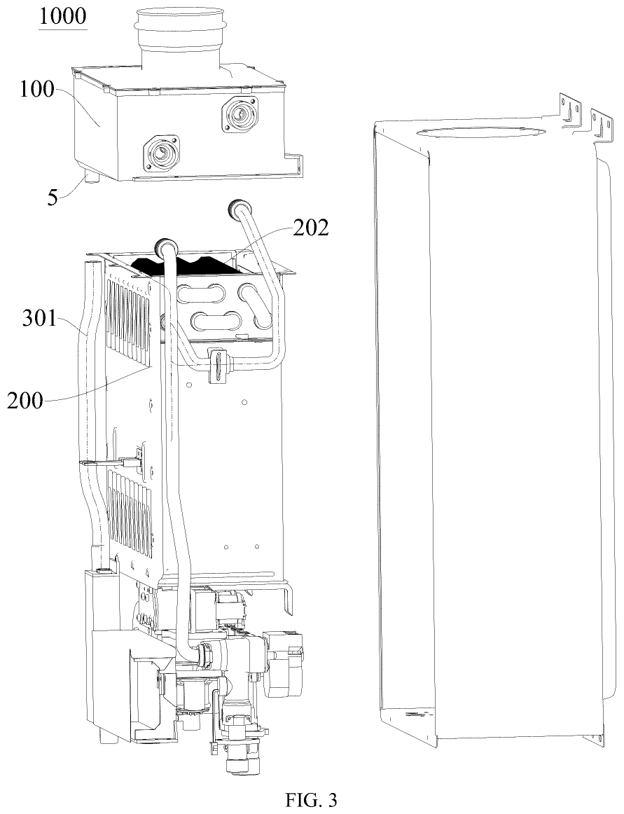

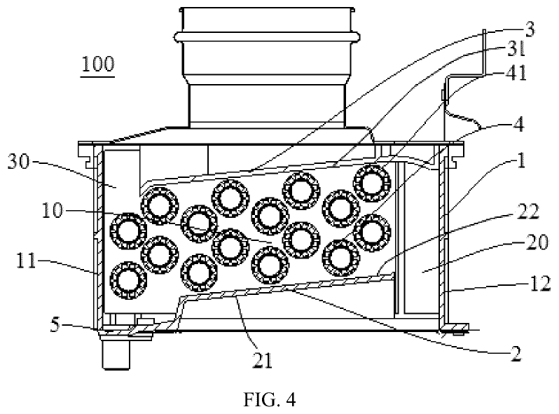

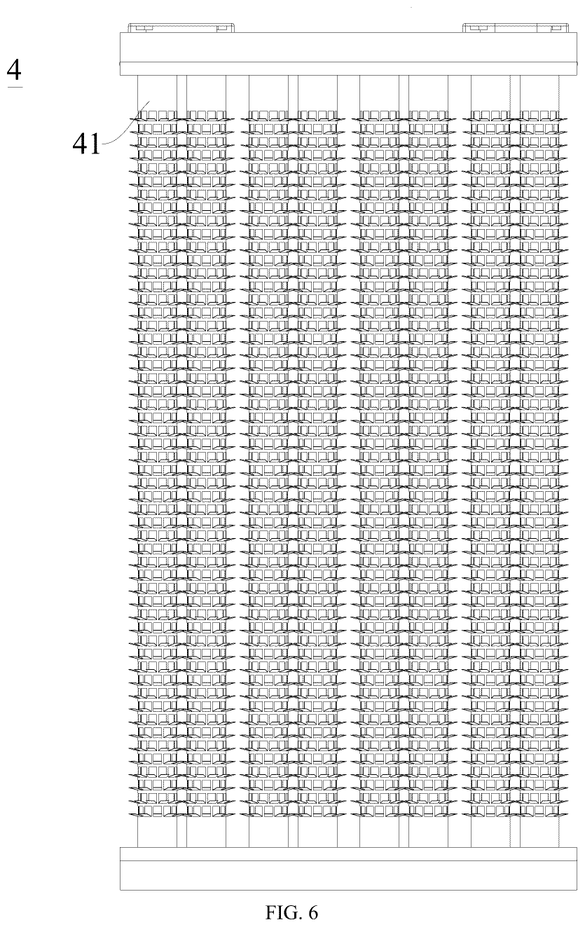

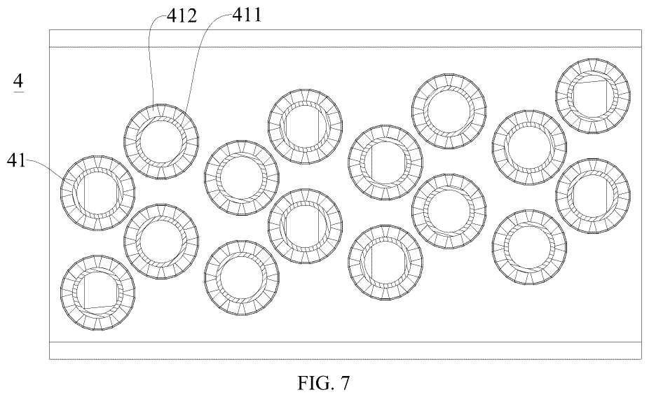

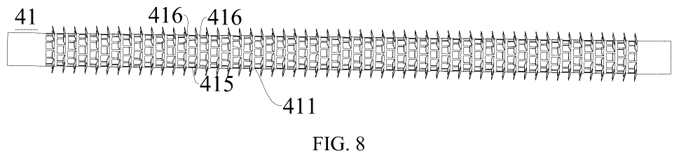

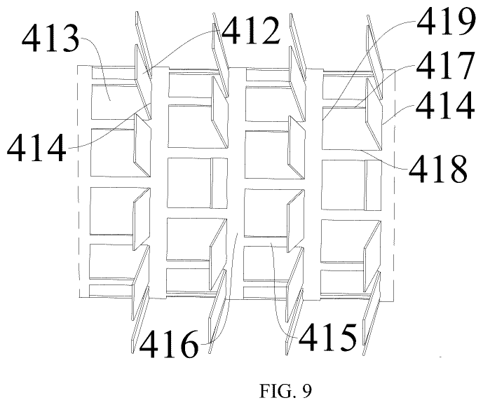

The heat exchanger assembly according to the embodiments of the present disclosure is described below with reference to FIG. 1 to FIG. 9.

The heat exchanger assembly according to an embodiment of the present disclosure may include a combustion assembly 200, a first heat exchanger 202, a flue gas passage 100, and the second heat exchanger 4.

The combustion assembly 200 has a combustion chamber 201. The first heat exchanger 202 is located in the combustion chamber 201. A gas undergoes combustion in the combustion chamber 201. Flue gas generated after the combustion exchanges heat with the first heat exchanger 202 in the combustion chamber 201, and then enters the flue gas passage 100.

The flue gas passage 100 has a condensation chamber 10, and is configured to receive flue gas from the combustion chamber 201 and to discharge the flue gas out of the heat exchanger assembly. The second heat exchanger 4 is disposed in the condensation chamber 10 and configured to exchange heat with the flue gas entering the flue gas passage 100. That is, the flue gas after exchanging the heat with the first heat exchanger may further reach the flue gas passage 100, and enter the condensation chamber 10 of the flue gas passage 100 to exchange heat with the second heat exchanger 4 in the condensation chamber 10. After two heat exchanges the energy in the flue gas can be fully exchanged. Therefore, the heat exchanger has a high heat exchange efficiency, which achieves the energy saving and emission reduction.

In addition, since the second heat exchanger 4 is integrated in the flue gas passage 100, a space in the flue gas passage 100 is used for the heat exchange with the flue gas. As a result, the heat exchanger assembly makes full use of the residual heat in the flue gas when exchanging heat with the flue gas, which improves the heat exchange efficiency, and achieves the energy saving and emission reduction without occupying other spaces. In this way, an overall structure of the heat exchanger assembly is simple and compact. Therefore, the structure of the heat exchanger assembly is simplified to reduce the overall volume of the water heater 1000, which facilitates the manufacturing and applications of the water heater 1000.

With the heat exchanger assembly according to the embodiments of the present disclosure, the structure of the heat exchanger can be simplified to reduce the overall volume of the water heater 1000 while the heat exchange efficiency can be improved to achieve the energy saving and emission reduction.

As illustrated in FIG. 1 to FIG. 3, the combustion assembly 200 includes a combustion housing 203. The combustion chamber 201 is defined in the combustion housing 203. The combustion housing 203 can not only protect an inner structure of the combustion assembly 200 at an outer side of the combustion assembly 200, but also guide the flue gas generated by the combustion to enable the flue gas to flow in a predetermined direction.

The flue gas passage 100 includes a flue gas housing 1. The condensation chamber 10 is defined in the flue gas housing 1. The flue gas housing 1 can not only protect an inner structure of the flue gas passage 100 at an outer side of the flue gas passage 100, but also guide the flue gas received by the flue gas passage 100 from the combustion chamber 201 to enable the flue gas to flow in a predetermined direction and be discharged from a flue gas vent.

Further, the flue gas housing 1 is disposed at a top of the combustion housing 203. As a result, the flue gas generated by gas combustion in the combustion chamber 201 flows upwards under guidance of a burner housing and is received by the flue gas housing 1. The flue gas enters the condensation chamber 10 under guidance of the flue gas passage 100, undergoes a second-stage heat exchange in the condensation chamber 10 defined by the flue gas housing 1, and then is discharged from the heat exchanger assembly under guidance of the flue gas passage 100.

In some embodiments, the flue gas housing 1 and the combustion housing 203 may be constructed as one piece.

In other embodiments, the flue gas housing 1 may be disposed at a side of the combustion housing 203 in a horizontal direction, as long as the flue gas housing 1 is able to receive the flue gas from the combustion chamber 201. The present disclosure is not limited in this regard.

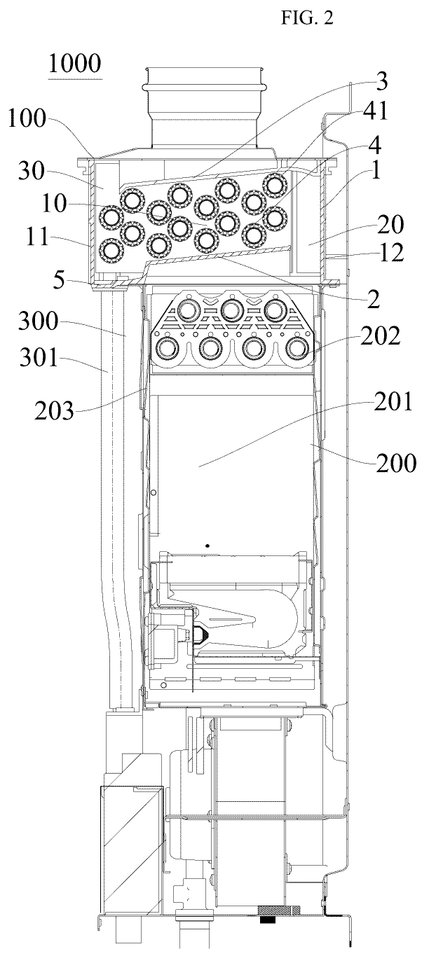

As illustrated in FIG. 2, in some embodiments, the combustion housing 203 has an opening at the top of the combustion housing 203. The flue gas housing 1 has an opening at a bottom of the flue gas housing 1. The opening at the bottom of the flue gas housing 1 is in communication with the opening at the top of the combustion housing 203 to enable the flue gas housing 1 to receive the flue gas from the combustion chamber 201.

A first partition 2 is provided between the flue gas housing 1 and the combustion housing 203. The first partition 2 is configured to separate the combustion chamber 201 from the condensation chamber 10. That is, the condensation chamber 10 is formed between the first partition 2 and the flue gas housing 1, and the combustion chamber 201 is formed between the first partition 2 and the combustion housing 203. A communication opening 20 is formed between the first partition 2 and the flue gas housing 1 and/or the combustion housing 203. The condensation chamber 10 is in communication with the combustion chamber 201 through the communication opening 20.

As a result, the flue gas generated in the combustion chamber 201 may flow upwards from bottom to top until it flows to the first partition 2. Under blockage of the first partition 2, the flue gas may flow towards a part having a smallest resistance to the flue gas, i.e., towards the communication opening 20 formed between the first partition 2 and the flue gas housing 1 or the combustion housing 203. The flue gas flows into the condensation chamber 10 through the communication opening 20, undergoes the two heat exchanges in the condensation chamber 10, and then is discharged.

As illustrated in FIG. 2, the first partition 2 extends obliquely from bottom to top in a direction close to the communication opening 20. A surface, e.g., a bottom surface, of the first partition 2 facing towards the combustion chamber 201 is constructed as a first guide surface 21. The first guide surface 21 is configured to guide the flue gas from the combustion chamber 201 to flow towards the communication opening 20. With the first guide surface 21, a flow direction of the flue gas can be controlled to enable the flue gas to flow towards a side portion of the condensation chamber 10.

In an exemplary embodiment of the present disclosure, the flue gas generated in the combustion chamber 201 may flow upwards from the bottom to the top until it flows to the first partition 2. Under guidance of the first guide surface 21 formed by the surface of the first partition 2, the flue gas flows towards the communication opening 20. The flue gas flows through the communication opening 20 into the condensation chamber 10, undergoes the two heat exchanges in the condensation chamber 10, and then is discharged.

As illustrated in FIG. 1 to FIG. 4, the heat exchanger assembly further includes a condensate water collector 5. Condensate water produced by condensation during the heat exchange of the flue gas in the condensation chamber 10 may converge at the condensate water collector 5 and be discharged through the condensate water collector 5. In this way, the condensate water can be prevented from corroding an inner structure of the flue gas housing 1, which prolongs a service life of the heat exchanger assembly.

A surface of the first partition 2 facing towards the combustion chamber 10 is constructed as a second guide surface 22. The second guide surface 22 extends downwards obliquely in a direction close to the condensate water collector 5. The second guide surface 22 is configured to at least guide the condensate water in the condensation chamber 10 to flow towards the condensate water collector 5. Therefore, the condensate water can be prevented from being retained in the condensation chamber 10 to avoid corrosion to the inner structure of the flue gas housing 1, which prolongs the service life of the heat exchanger assembly.

As illustrated in FIG. 1, in any horizontal direction, the second guide surface 22 extends downwards obliquely in the direction close to the condensate water collector 5. The condensate water collector 5 is located at a lowest position of a surface of the condensation chamber 10 to further ensure that no condensate water is retained.

As illustrated in FIG. 2 to FIG. 4, the flue gas housing 1 has a first wall 11 and a second wall 12 opposite to the first wall 11. The condensate water collector 5 is disposed at the first partition 2 and close to the first wall 11. The communication opening 20 is located between the first partition 2 and the second wall 12. The communication opening 20 and the condensate water collector 5 are formed at two sides, respectively, which allows a structural arrangement inside the flue gas passage 100 to be reasonable. Therefore, an arrangement of a drainage structure can be facilitated. Further, the condensate water can be prevented from flowing back to the combustion chamber 201 through the communication opening 20.

The first partition 2 is located at the bottom of the flue gas housing 1 to separate the combustion chamber 201 from the condensation chamber 10. A first end of the first partition 2 is connected to the first wall 11 of the flue gas housing 1. A position where the first partition 2 is connected to the first wall 11 of the flue gas housing 1 is low in height. The condensate water is formed at a position close to the first wall 11. A second end of the first partition 2 is spaced apart from the second wall 12 of the flue gas housing 1 to form the communication opening 20. A part of the first partition 2 close to the second wall 12 is high in height, which facilitates guiding, by the first partition 2, the flue gas towards the communication opening 20.

Further, the flue gas housing 1 has a third wall and a fourth wall opposite to the third wall. The first partition 2 is also connected to both the third wall and the fourth wall simultaneously to enable the first partition 2 to be stably disposed between the condensation chamber 10 and the combustion chamber 201, achieving flow guidance.

As illustrated in FIG. 1 to FIG. 4, the heat exchanger assembly further includes a drainage pipe 301. The first wall 11 of the flue gas housing 1 extends beyond a side wall of the combustion housing 203 at a same side as the first wall 11 to form a mounting space 300 between the first wall 11 and the side wall of the combustion housing 203. The condensate water collector 5 extends into the mounting space 300. The drainage pipe 301 is connected to the condensate water collector 5 and located in the mounting space 300. The mounting space 300 is isolated from the combustion chamber 201. Therefore, the drainage pipe 301 and the condensate water collector 5 are prevented from being affected by a high temperature in the combustion chamber 201, which avoids secondary vaporization of the condensate water to ensure the condensate water to be steadily discharged. In addition, a service life of the drainage pipe 301 can be prolonged.

As illustrated in FIG. 2 to FIG. 4, the heat exchanger assembly further includes a second partition 3. The second partition 3 is disposed in the flue gas passage 100 and located opposite to the combustion chamber 201 with respect to the first partition 2. The condensation chamber 10 is located between the first partition 2 and the second partition 3 to form a larger condensation chamber 10 in the flue gas passage 100. Therefore, the second heat exchanger 4 arranged in the condensation chamber 10 can also be made larger, and thus a heat exchange area between the second heat exchanger 4 and the flue gas is larger, improving the heat exchange efficiency of the heat exchanger assembly.

In an exemplary embodiment of the present disclosure, the flue gas generated in the combustion chamber 201 may flow upwards from the bottom to the top until it flows to the first partition 2. Under the guidance of the first guide surface 21 formed by the surface of the first partition 2, the flue gas flows towards the communication opening 20. The flue gas flows through the communication opening 20 to a side wall at a side of the condensation chamber 10 and undergoes the two heat exchanges in the condensation chamber 10. Since the flue gas in the condensation chamber 10 has a tendency to flow upwards, the flue gas may flow upwards and be brought into contact with a surface of the second partition 3. In this way, the flue gas is prevented from being discharged directly through the flue gas vent to undergo the heat exchange in the condensation chamber 10 for a longer period of time. Therefore, the heat exchange efficiency between the second heat exchanger 4 and the flue gas is improved.

As illustrated in FIG. 2 to FIG. 4, the second partition 3 is located above the first partition 2. A surface of the second partition 3 facing towards the first partition 2 is constructed as a third guide surface 31 configured to guide the flue gas. The third guide surface 31 is able to guide the flue gas to the communication opening 20. Since the third guide surface 31 extends obliquely downwards in the direction close to the communication opening 20 and the flue gas has the tendency to flow upwards, the flue gas undergoes the heat exchange in the condensation chamber 10 for a longer period of time, which improves the heat exchange efficiency between the second heat exchanger 4 and the flue gas.

In some embodiments, the second partition 3 may also extend obliquely downwards in the direction close to the condensate water collector 5, to prevent the condensate water from being retained at the second partition 3. Therefore, the service life of the heat exchanger assembly is further prolonged.

As illustrated in FIG. 2 to FIG. 4, the flue gas housing 1 has the first wall 11 and the second wall 12 opposite to the first wall 11. The first partition 2 has the first end connected to the first wall 11 of the flue gas housing 1 and the second end spaced apart from the second wall 12 of the flue gas housing 1 to form the communication opening 20. The second partition 3 has a first end spaced apart from the first wall 11 to form an exhaust outlet 30 for exhausting the flue gas and a second end connected to the second wall 12.

Since the resistance to the flue gas is small at the exhaust outlet 30, the flue gas further has a tendency to flow towards the exhaust outlet 30. That is, the flue gas may flow from a lower part of a second side to an upper part of a first side in the condensation chamber 10. Considering that the exhaust outlet 30 and the communication opening 20 are located at two opposite corners of the condensation chamber 10, respectively, a distance over which the flue gas flows between the exhaust outlet 30 and the communication opening 20 is long. Therefore, the flue gas undergoes the heat exchange in the condensation chamber 10 for a longer period of time, which improves the heat exchange efficiency between the second heat exchanger 4 and the flue gas.

In an exemplary embodiment of the present disclosure, the flue gas generated in the combustion chamber 201 may flow upwards from the bottom to the top until it flows to the first partition 2. Under the guidance of the first guide surface 21 formed by the surface of the first partition 2, the flue gas flows towards the communication opening 20 close to the second wall 12. The flue gas flows to the second side in the condensation chamber 10 through the communication opening 20 and flows upwards. Under guidance of the third guide surface 31 formed by the surface of the second partition 3, the flue gas flows towards the upper part of the first side in the condensation chamber 10. The flue gas is discharged from the condensation chamber 10 through the exhaust outlet 30 located at the first side and discharged through a flow channel defined between the second partition 3 and a top wall of the flue gas housing 1.

A specific embodiment of the water heater 1000 is described below in conjunction with the illustrated accompanying drawings.

As illustrated in FIG. 1 to FIG. 9, the water heater 1000 includes the combustion assembly 200, the first heat exchanger 202, the flue gas passage 100, and the second heat exchanger 4. The combustion assembly 200 includes the combustion housing 203. The combustion chamber 201 is defined in the combustion housing 203. The first heat exchanger 202 is located in the combustion chamber 201. The gas undergoes the combustion in the combustion chamber 201. The flue gas generated after the combustion exchanges heat with the first heat exchanger 202 in the combustion chamber 201, and then enters the flue gas passage 100.

The flue gas passage 100 is configured to receive the flue gas from the combustion chamber 201 and to discharge the flue gas out of the heat exchanger assembly. The flue gas passage 100 includes the flue gas housing 1. The condensation chamber 10 is defined in the flue gas housing 1. The second heat exchanger 4 is disposed in the condensation chamber 10 and is configured to exchange heat with the flue gas entering the flue gas passage 100.

The combustion housing 203 has the opening at the top of the combustion housing 203. The flue gas housing 1 has the opening at the bottom of the flue gas housing 1 and is disposed at the top of the combustion housing 203. The opening at the bottom of the flue gas housing 1 is in communication with the opening at the top of the combustion housing 203. The first partition 2 is provided between the flue gas housing 1 and the combustion housing 203. Further, the second partition 3 is provided above the first partition 2. The condensation chamber 10 is formed between the first partition 2, the second partition 3, and the flue gas housing 1. The combustion chamber 201 is formed between the first partition 2 and the combustion housing 203.

The flue gas housing 1 has the first wall 11 and the second wall 12 opposite to the first wall 11. The first partition 2 has the first end connected to the first wall 11 of the flue gas housing 1. The condensate water collector 5 is provided at a position of the first partition 2 close to the first end. The second end of the first partition 2 is spaced apart from the second wall 12 of the flue gas housing 1 to form the communication opening 20. The second partition 3 has the first end spaced apart from the first wall 11 to form the exhaust outlet 30 for exhausting the flue gas and the second end connected to the second wall 12.

The heat exchanger assembly further includes the drainage pipe 301. The first wall 11 of the flue gas housing 1 extends beyond the side wall of the combustion housing 203 at the same side as the first wall 11 to form the mounting space 300 between the first wall 11 and the side wall of the combustion housing 203. The condensate water collector 5 extends into the mounting space 300. The drainage pipe 301 is connected to the condensate water collector 5 and located in the mounting space 300. The mounting space 300 is isolated from the combustion chamber 201. Therefore, the drainage pipe 301 and the condensate water collector 5 are prevented from being affected by the high temperature in the combustion chamber 201, which avoids the secondary vaporization of the condensate water to ensure the condensate water to be steadily discharged. In addition, the service life of the drainage pipe 301 can be prolonged.

The flue gas housing 1 further has the third wall and the fourth wall opposite to the third wall. Further, each of the first partition 2 and the second partition 3 is connected to the third wall and the fourth wall simultaneously to enable the first partition 2 and the second partition 3 to be stably disposed at upper and lower sides of the condensation chamber 10 to achieve the flow guidance.

The first partition 2 extends obliquely from the bottom to the top in a direction close to the second wall 12 of the flue gas housing 1. Therefore, the surface of the first partition 2 facing towards the combustion chamber 201 is constructed as the first guide surface 21. The first guide surface 21 extends from the bottom to the top in the direction close to the communication opening 20. In this way, the first guide surface 21 is able to guide the flue gas in the combustion chamber 201 to flow towards the communication opening 20. The surface of the first partition 2 facing towards the condensation chamber 10 is constructed as the second guide surface 22. The second guide surface 22 extends obliquely downwards in the direction close to the condensate water collector 5 to guide the condensate water in the condensation chamber 10 to flow towards the condensate water collector 5.

The second partition 3 extends obliquely from the bottom to the top in the direction close to the second wall 12 of the flue gas housing 1. The exhaust outlet 30 is formed at a lower height than other positions on the second partition 3. Therefore, the flue gas undergoes the heat exchange in the condensation chamber 10 for a longer period of time, which improves the heat exchange efficiency between the second heat exchanger 4 and the flue gas.

In some embodiments, the second heat exchanger 4 may include five serpentine corrugated pipes connected in parallel and offset from each other. In other embodiments, the second heat exchanger 4 includes a plurality of heat exchange tubes 41 connected in parallel.

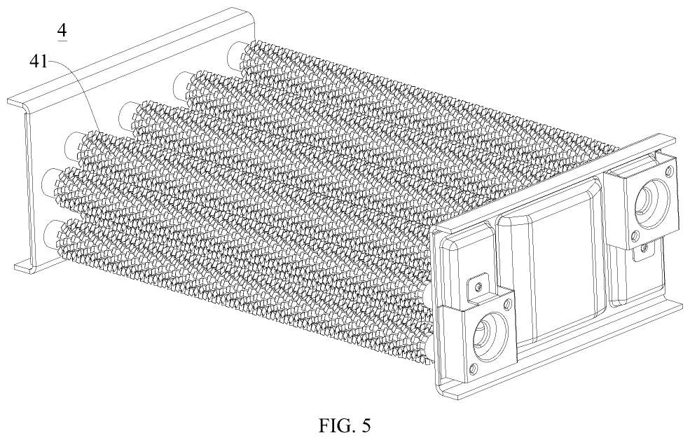

As illustrated in FIG. 5 to FIG. 9, the heat exchange tube 41 includes a tube body 411 and a bare tube portion located at two sides of the tube body 411.

The heat exchange tube 41 is machined from a bare tube. After machining of the bare tube, a non-through recess 413 is formed at the tube body 411 at a machining place. An original material in the recess 413 is folded outwards to form a fin member 412. The tube body 411 has a wall thickness at the recess 413 smaller than a wall thickness of a remaining region of the tube body 411. The recess 413 has a depth of 0.3 mm.

After the material in the recess 413 is cut and separated from the tube body 411, a side of the material remains connected to the tube body 411, while the rest of the material is folded outwards to form the fin member 412. A connection of the fin member 412 with the tube body 411 is constructed as a crease 414 of the fin member 412. The crease 414 of the fin member 412 is perpendicular to an axial direction of the heat exchange tube 41. An extension direction of the fin member 412 is also perpendicular to the axial direction of the heat exchange tube 41.

The tube body 411 is divided axially into a to-be-machined segment 415 (also referred to as a “target segment”) and a transition segment 416 that are alternately arranged. A plurality of fin members 412 arranged at intervals is uniformly distributed circumferentially at the to-be-machined segment 415. No processing is performed on the transition segment 416. The fin members 412 on two adjacent to-be-machined segments 415 are offset from each other circumferentially.

That is, the recesses 413 formed by machining the heat exchange tube 41 are arranged at intervals circumferentially and axially. Since the recesses 413 are arranged at intervals, a process of machining the fin member 412 is prevented from affecting a strength of the tube body 411. Therefore, reliability of the heat exchange tube 41 can be ensured.

In addition, gaps between the fin members 412 are increased circumferentially and axially to prevent the fin members 412 from affecting the flow of the flue gas in the heat exchange chamber due to being too dense. The recesses 413 arranged at intervals may further enable alternate formations of the recesses 413 and protrusions on the tube body 411. The recesses 413 and the protrusions can increase a heat exchange area of the tube body 411, which improves the heat exchange efficiency of the heat exchanger.

The fin members 412 are uniformly distributed at the tube body 411, in such a manner that various parts of the heat exchange tube 41 have a uniform temperature. In this way, damages to the heat exchange tube 41 due to uneven temperatures can be avoided to prolong the service life of the heat exchange tube 41.

As illustrated in FIG. 5, the recess 413 has a first cut edge 417 and a second cut edge 418 that are connected to the crease 414 and a third cut edge 419 opposite to the crease 414. The first cut edge 417 and the second cut edge 418 extend in the axial direction of the heat exchange tube 41. The third cut edge 419 is connected to the first cut edge 417 and the second cut edge 418 and is parallel to the crease 414. Therefore, the recess 413 in a rectangular shape can be formed at the heat exchange tube 41. Individual recesses 413 are arranged in an orderly manner at the tube body 411, and thus the fin members 412 having a larger overall heat exchanges can be cut out of the tube body 411.

The water heater 1000 according to the embodiments of the present disclosure can be more energy efficient by adopting the above-mentioned heat exchanger assembly.

In the description of the present disclosure, it should be understood that, the orientation or the position indicated by terms such as “center”, “longitudinal”, “lateral”, “length”, “width”, “thickness”, “over”, “below”, “front”, “rear”, “left”, “right”, “vertical”, “horizontal”, “top”, “bottom”, “inner”, “outer”, “clockwise”, “anti-clockwise”, “axial”, “radial”, and “circumferential” should be construed to refer to the orientation and the position as shown in the drawings, and is only for the convenience of describing the present disclosure and simplifying the description, rather than indicating or implying that the pointed device or element must have a specific orientation, or be constructed and operated in a specific orientation, and therefore cannot be understood as a limitation of the present disclosure.

Other configurations of the water heater 1000 belong to the related art and are known to those skilled in the art, and thus will not be described in detail here.

Reference throughout this specification to “an embodiment”, “some embodiments”, “illustrative embodiments”, “an example”, “a specific example”, or “some examples” means that a particular feature, structure, material, or characteristic described in connection with the embodiment or example is included in at least one embodiment or example of the present disclosure. The appearances of the above phrases in various places throughout this specification are not necessarily referring to the same embodiment or example. Further, the particular features, structures, materials, or characteristics may be combined in any suitable manner in one or more embodiments or examples.

Although embodiments of the present disclosure have been illustrated and described, it is conceivable for those skilled in the art that various changes, modifications, replacements, and variations can be made to these embodiments without departing from the principles and spirit of the present disclosure. The scope of the present disclosure shall be defined by the claims as appended and their equivalents.

what is claimed is:

1. A heat exchanger assembly comprising:
a combustion assembly having a combustion chamber;
a first heat exchanger located in the combustion chamber;
a flue gas passage having a condensation chamber, the flue gas passage being configured to receive flue gas from the combustion chamber and to discharge the flue gas out of the heat exchanger assembly; and
a second heat exchanger disposed in the condensation chamber and configured to exchange heat with the flue gas entering the flue gas passage.

2. The heat exchanger assembly according to claim 1, wherein:
the combustion assembly includes a combustion housing; and
the flue gas passage includes a flue gas housing disposed at a top of the combustion housing.

3. The heat exchanger assembly according to claim 2, further comprising:
a partition between the flue gas housing and the combustion housing, the partition being configured to separate the combustion chamber from the condensation chamber;
wherein a communication opening is formed between the partition and at least one of the flue gas housing or the combustion housing, the condensation chamber being in communication with the combustion chamber through the communication opening.

4. The heat exchanger assembly according to claim 3, wherein a surface of the partition facing towards the combustion chamber is constructed as a guide surface, the guide surface being configured to guide the flue gas from the combustion chamber to flow towards the communication opening.

5. The heat exchanger assembly according to claim 4,
wherein the guide surface is a first guide surface;
the heat exchanger assembly further comprising:
a condensate water collector;
wherein a surface of the partition facing towards the condensation chamber is constructed as a second guide surface, the second guide surface being configured to at least guide condensate water in the condensation chamber to flow towards the condensate water collector.

6. The heat exchanger assembly according to claim 3, further comprising:
a condensate water collector;
wherein a surface of the partition facing towards the condensation chamber is constructed as a guide surface, the guide surface being configured to at least guide condensate water in the condensation chamber to flow towards the condensate water collector.

7. The heat exchanger assembly according to claim 6, wherein:
the partition is located at a bottom of the flue gas housing and has:
a first end connected to a first wall of the flue gas housing; and
a second end spaced apart from a second wall of the flue gas housing to form the communication opening, the second wall being arranged opposite to the first wall; and
the condensate water collector is disposed at the partition and located closer to the first wall than to the second wall.

8. The heat exchanger assembly according to claim 7,
wherein the first wall of the flue gas housing extends beyond a side wall of the combustion housing at a same side as the first wall of the flue gas housing, a mounting space being formed between the first wall and the side wall of the combustion housing, and the condensate water collector extending into the mounting space; and
the heat exchanger assembly further comprising:
a drainage pipe connected to the condensate water collector, the drainage pipe being located in the mounting space.

9. The heat exchanger assembly according to claim 3,
wherein the partition is a first partition;
the heat exchanger assembly further comprising:
a second partition disposed in the flue gas passage and located opposite to the combustion chamber with respect to the first partition, the condensation chamber being located between the first partition and the second partition.

10. The heat exchanger assembly according to claim 9, wherein the second partition is located above the first partition, a surface of the second partition facing towards the first partition being constructed as a guide surface for guiding the flue gas.

11. The heat exchanger assembly according to claim 10, wherein:
the flue gas housing has a first wall and a second wall opposite to the first wall; and
the second partition has a first end spaced apart from the first wall to form an exhaust outlet for exhausting the flue gas, and a second end connected to the second wall.

12. A water heater comprising:
a heat exchanger assembly including:
a combustion assembly having a combustion chamber;
a first heat exchanger located in the combustion chamber;
a flue gas passage having a condensation chamber, the flue gas passage being configured to receive flue gas from the combustion chamber and to discharge the flue gas out of the heat exchanger assembly; and
a second heat exchanger disposed in the condensation chamber and configured to exchange heat with the flue gas entering the flue gas passage.

13. The water heater according to claim 12, wherein:
the combustion assembly includes a combustion housing; and
the flue gas passage includes a flue gas housing disposed at a top of the combustion housing.

14. The water heater according to claim 13, wherein:
the heat exchanger assembly further includes a partition between the flue gas housing and the combustion housing, the partition being configured to separate the combustion chamber from the condensation chamber; and
a communication opening is formed between the partition and at least one of the flue gas housing or the combustion housing, the condensation chamber being in communication with the combustion chamber through the communication opening.

15. The water heater according to claim 14, wherein a surface of the partition facing towards the combustion chamber is constructed as a guide surface, the guide surface being configured to guide the flue gas from the combustion chamber to flow towards the communication opening.

16. The water heater according to claim 15, wherein:
the guide surface is a first guide surface;
the heat exchanger assembly further includes a condensate water collector; and
a surface of the partition facing towards the condensation chamber is constructed as a second guide surface, the second guide surface being configured to at least guide condensate water in the condensation chamber to flow towards the condensate water collector.

17. The water heater according to claim 14, wherein:
the heat exchanger assembly further includes a condensate water collector; and
a surface of the partition facing towards the condensation chamber is constructed as a guide surface, the guide surface being configured to at least guide condensate water in the condensation chamber to flow towards the condensate water collector.

18. The water heater according to claim 17, wherein:
the partition is located at a bottom of the flue gas housing and has:
a first end connected to a first wall of the flue gas housing; and
a second end spaced apart from a second wall of the flue gas housing to form the communication opening, the second wall being arranged opposite to the first wall; and
the condensate water collector is disposed at the partition and located closer to the first wall than to the second wall.

19. The water heater according to claim 18, wherein:
the first wall of the flue gas housing extends beyond a side wall of the combustion housing at a same side as the first wall of the flue gas housing, a mounting space being formed between the first wall and the side wall of the combustion housing, and the condensate water collector extending into the mounting space; and
heat exchanger assembly further includes a drainage pipe connected to the condensate water collector, the drainage pipe being located in the mounting space.

20. The water heater according to claim 14, wherein:
the partition is a first partition;
the heat exchanger assembly further includes a second partition disposed in the flue gas passage and located opposite to the combustion chamber with respect to the first partition; and
the condensation chamber being located between the first partition and the second partition.
